(19) United States
(12) Patent Application Publication
(10) Pub. No.: US 2026/0005644 A1
(43) Pub. Date: Jan. 1, 2026

(54) FULLY AUTOMATED FACTORY FOR SOLAR PLANT

(71) Applicant: Terabase Energy, Inc., Berkeley, CA (US)

(72) Inventors: Adam Hansel, Davis, CA (US); Cedric Boss, Richmond, CA (US); Brian Coleman, Portland, OR (US); Soren Jensen, Corte Madera, CA (US)

(73) Assignee: Terabase Energy, Inc., Berkeley, CA (US)

(21) Appl. No.: 18/757,407

(22) Filed: Jun. 27, 2024

(51) Int. Cl. H02S 20/32; H02S 30/10

(52) U.S. Cl. CPC H02S 20/32; H02S 30/10

(57) ABSTRACT

A large solar farm comprises one or more solar arrays, each with hundreds of rows of solar modules. Construction of a solar farm is a process that typically involves labor-intensive work that requires a large amount of human effort for solar table assembling and installation. The present invention discloses fully automatic factory embodiments to improve centralized solar table assembling efficiency for large solar plants. An automatic factory may comprise a panel conveyor, a torque tube dispenser, a table assembly station, and a table delivery zone for automatic solar table assembling, dispatching, and storing. The application of the described embodiments may improve installation efficiency, assembly quality, and safety during the installation process so that the overall construction process for large solar plants may be completed efficiently and safely with high quality.

### TECHNICAL FIELD

The present disclosure relates generally to solar power plant installation. More particularly, the present disclosure relates to a fully automatic factory to improve centralized solar table assembling efficiency for large solar plants.

### BACKGROUND

The importance of solar power systems is well understood by one of skill in the art. Government agencies and companies are scaling the size and number of solar solutions within their energy infrastructure. This transition from traditional fossil fuel energy systems to solar energy solutions presents several challenges. One challenge is the ability to improve on-site installation efficiency, quality, and safety during the installation process of a large amount of solar modules. Such a process typically involves labor-intensive work that requires a large amount of human effort for solar table assembling and installation.

FIG. 1 shows a typical solar farm 105 comprising an array of installed solar structures 110, e.g., solar tables. Each solar structure comprises multiple solar modules 115. A large-scale solar farm typically includes hundreds of thousands of solar modules that are located across a multi-hundred-acre terrain and that are electrically coupled to provide a source of energy. In a typical installation process, multiple solar modules are securely aligned and attached to a metal structure (purlins or torque tube) to form a row of solar modules. A solar farm may comprise one or more solar arrays, with each solar array having hundreds of rows of solar modules. A row of solar modules may be supported by supporting structures (e.g., ground piles, ground screws, ballasted foundations, etc.) with the metal structure securely fastened to supporting structures at a desired rotational angle such that the solar modules are oriented for maximum energy production efficiency.

Large-scale systems are often located in remote areas and involve complex management of materials, resources, logistics, labor, etc. It is very desirable to improve installation efficiency, assembly quality, and safety during the installation process so that the overall construction process for large solar plants can be completed efficiently and safely with high quality.

What is needed are systems and methods that can effectively implement solar table assembly for improved efficiency, safety, and quality to facilitate large solar projects.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that the description is not intended to limit the scope of the invention to these particular embodiments. Items in the figures may be not to scale.

FIG. 1 depicts a general layout of a large-scale solar site.

FIG. 2A depicts a perspective view of an automatic factory for centralized solar table assembly according to various embodiments of the invention.

FIG. 2B depicts a perspective view of the automatic factory for centralized solar table assembly with the roof structure hidden according to various embodiments of the invention.

FIG. 3 depicts another perspective view of an automatic factory for centralized solar table assembly according to various embodiments of the invention.

FIG. 4 depicts a pallet conveyor as a panel conveyor loader in accordance with various embodiments of the invention.

FIG. 5A depicts a static pallet station as a panel conveyor in accordance with various embodiments of the invention.

FIG. 5B depicts a static pallet as a panel conveyor in the factory with the roof structure hidden in accordance with various embodiments of the invention.

FIG. 6A depicts a rotary table as a panel conveyor in accordance with various embodiments of the invention.

FIG. 6B depicts a rotary table as a panel conveyor in the factory with the roof structure hidden in accordance with various embodiments of the invention.

FIG. 7A depicts a perspective view of a torque tube with brackets in accordance with various embodiments of the invention.

FIG. 7B depicts a perspective view of a bracket in accordance with various embodiments of the invention.

FIG. 8 depicts an overview of a torque tube positioning system in accordance with various embodiments of the invention.

FIG. 9 graphically depicts a process for torque tube axial positioning in accordance with various embodiments of the invention.

FIG. 10A graphically depicts a process for torque tube orientation alignment in accordance with various embodiments of the invention.

FIG. 10B graphically depicts alternative approaches for torque tube orientation alignment in accordance with various embodiments of the invention.

FIG. 11 graphically depicts a process for torque tube proceeding for bracket attachment in accordance with various embodiments of the invention.

FIGS. 12-14 graphically depict a process for automatic bracket installation onto a torque tube in accordance with various embodiments of the invention.

FIG. 15 depicts the installation of a solar module onto a torque tube in accordance with various embodiments of the invention.

FIG. 16A depicts a top-down view of the automatic solar table assembly process in accordance with various embodiments of the invention.

FIG. 16B depicts a front side view and a back side view of a solar module in accordance with various embodiments of the invention.

FIG. 17 graphically depicts a process for automatic solar table assembly in accordance with various embodiments of the invention.

FIG. 18 graphically depicts a process for automatic solar module feeding in accordance with various embodiments of the invention.

FIG. 19 depicts a process for automatic solar table assembly in accordance with various embodiments of the invention.

FIG. 20 depicts a perspective view of filling assembled solar tables onto table racks in accordance with various embodiments of the invention.

FIG. 21 depicts a process view of filling assembled solar tables onto table racks in accordance with various embodiments of the invention.

FIG. 22 depicts a perspective view of loading an assembled solar table onto a mobile vehicle for delivery in accordance with various embodiments of the invention.

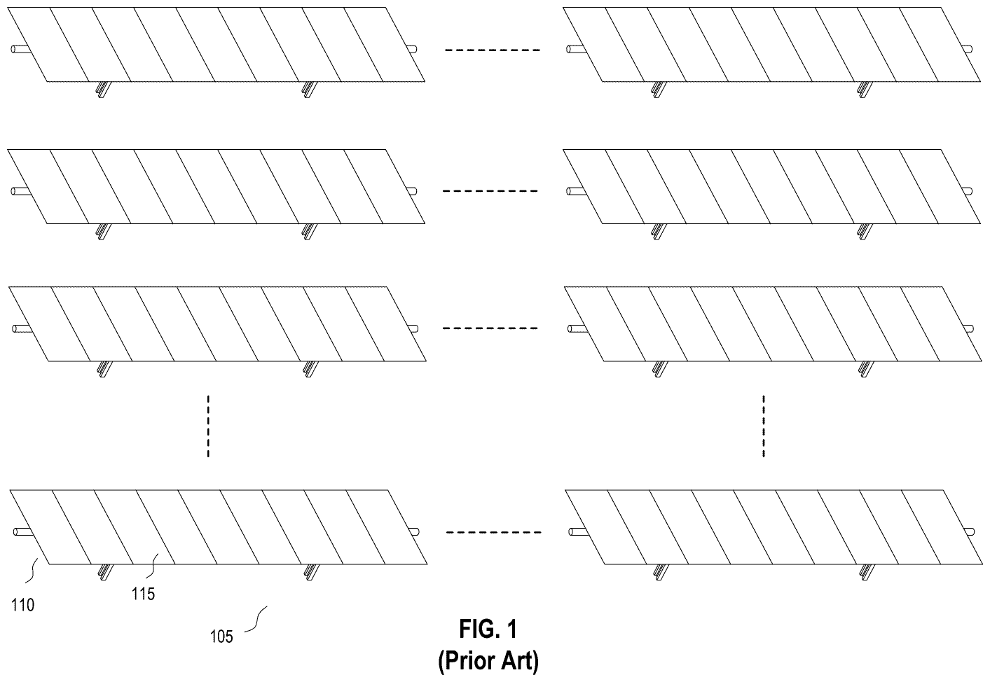

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method.

Components, or features, shown in diagrams are illustrative of exemplary embodiments of the invention and are meant to avoid obscuring the invention. It shall also be understood that throughout this discussion components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components in a system for tracking and managing production, productivity, safety and quality on large projects, such as a construction of large-scale solar farm.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A component, function, or structure is not limited to a single component, function, or structure; usage of these terms may refer to a grouping of related components, functions, or structures, which may be integrated and/or discrete.

Further, it shall be noted that: (1) certain components or functionals may be optional; (2) components or functions may not be limited to the specific description set forth herein; (3) certain components or functions may be assembled/combined differently; and (4) certain functions may be performed concurrently or in sequence.

In this document, “large-scale solar system” or “large solar projects” is defined as a solar system or project involving installation and/or operation of 1000 or more solar modules. The word “resources” refers to material, parts, components, equipment or any other items used to construct a solar table and/or solar system. The term “solar table” is defined as a structural assembly comprising one or more photovoltaic (PV) or solar modules and/or one or more module frames (or purlins) for module support. Some types of solar tables may have electrical harnesses and supplemental structures that allow them to connect to other solar tables or foundations/piles while other types do not have this supplemental structure. The term “torque tube” is defined as a structural component that supports multiple solar modules with proper alignment. Torque tubes are often part of tracking systems for optimal sunlight capture for solar modules. The term “panel conveyor” is defined a section comprising an incoming section where full panel crates are lined up waiting to enter the second stage, a pick station where a robot picks panels from the crate/pallet/slipper and loads them on an inspection conveyor, and an outbound subsection where the empty crates, pallets/slippers are lining up waiting to get removed from the conveyor. The term “transport/landing vehicle” is defined as a specifically designed vehicle to transport solar tables from the centralized solar table assembly factory for on-site installation or on-site storage. The transport/landing vehicle may be driven by personnel, controlled by remote control, or autonomously driven by a computer system.

Traditionally, a distributed construction process is adopted for solar module installation. In such an installation process, all mounting equipment for each solar module is individually assembled and installed at its location within the larger system. Such traditional deployment relies on materials being delivered to a deployment site via an access road. The materials are then processed and staged at the deployment site by a crew. A small portion of this delivered material is then moved by heavy equipment to a specific location where a solar module and mounting equipment are assembled and installed at an installation location. The step is then repeated for an adjacent installation location where materials are subsequently delivered, assembled, and installed for a neighboring solar table within the system. For a large solar system, such an installation process becomes costly and has challenges of consistency and reliability over the entire installation process.

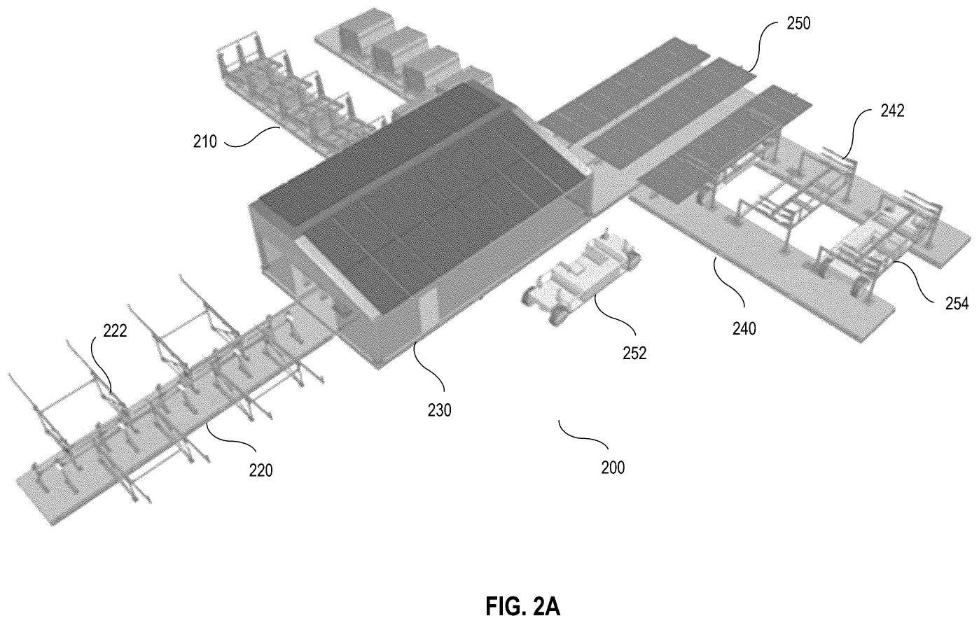

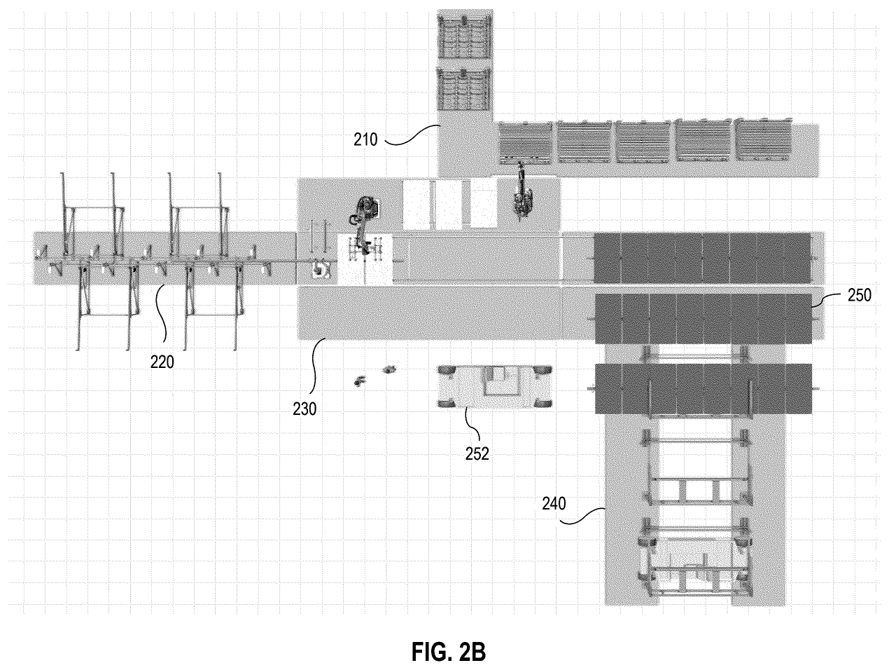

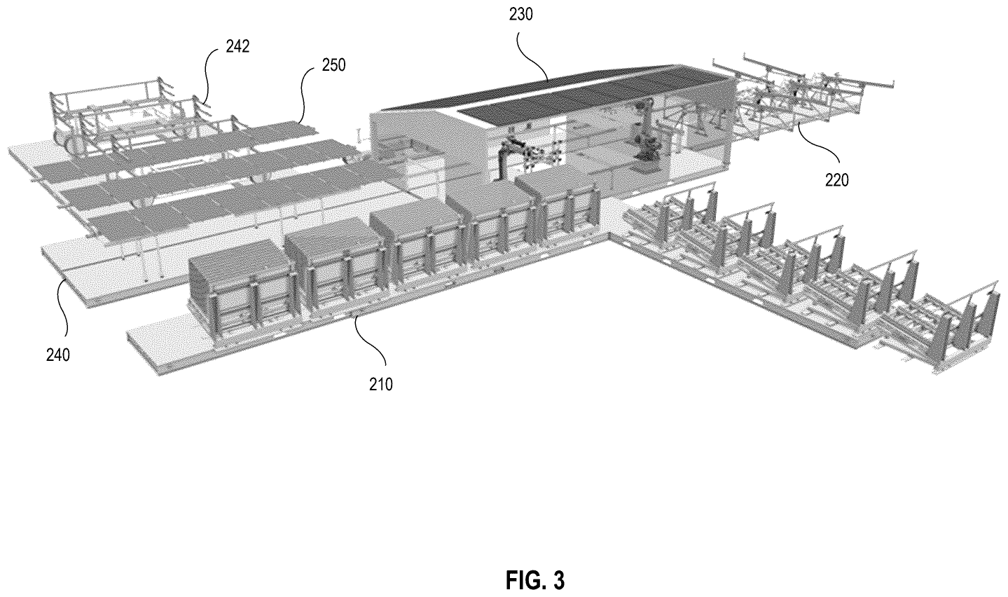

On the contrary, a centralized solar table assembly and installation may be implemented for large-scale solar systems. FIG. 2A, FIG. 2B, and FIG. 3 depict various perspective views of an automatic factory for centralized solar table assembly according to various embodiments of the invention. Resources, such as solar modules, torque tubes, mounting brackets, etc., are delivered to an automatic assembly factory 200 where a coordinated, automatic, and centralized solar table assembly process is performed. Assembled solar tables and equipment are moved from the factory 200 for on-site installation via motorized vehicles 252/254. The approach of utilizing a centralized and coordinated assembly factory may allow a more cost-effective and dynamic process of constructing large-scale solar systems.

As shown in FIG. 2A and FIG. 2B, the automatic assembly factory 200 comprises a module conveyor 210, a torque tube dispenser 220, a table assembly station 230, and a table delivery zone 240. The module 210 is a stage to receive solar module packs such that individual solar modules or solar modules are fetched from the module packs for solar table assembly. The torque tube dispenser 220 is a staging area comprising one or more dispenser station 222, where torque tubes may be loaded via telehandler and be fed into the table assembly station 230 for the production of solar tables. The table assembly station 230 is a station where solar modules and torque tubes are assembled together into solar tables 250. The assembled solar tables are then moved automatically to the table delivery zone 240 for filling onto table racks 242 or for delivery directly by motorized vehicles 252/254.

Embodiments of the fully automated factory allow more efficient distribution of material and better control of inventory with reduced labor hours. The throughput and build rate of solar farms are increased. By leveraging a fully automated process, much of the manual labor needed to move solar modules may be reduced or even eliminated. For example, assembly time for a solar table may be decreased in half from 4 minutes to 2 minutes or less. Since the assembly operation is less dependent on operators, throughput is more stable and maintained with consistent assembly quality as long as the factory is continuously replenished with material, e.g., solar modules, torque tubes, brackets, mounting hardware, etc. Furthermore, by reducing or eliminating heavy manual labor for full table assembling automation, the assembling operation may run longer under environmental constraints (temperature, humidity, ventilation, noise level, etc.) that may typically be challenging for manual labor operation.

Described hereinafter are embodiments of various components of the automatic assembly factory 200. The embodiments may be applied in various combinations to implement automatic solar table assembly and delivery.

### A. Embodiments of Panel Conveyor

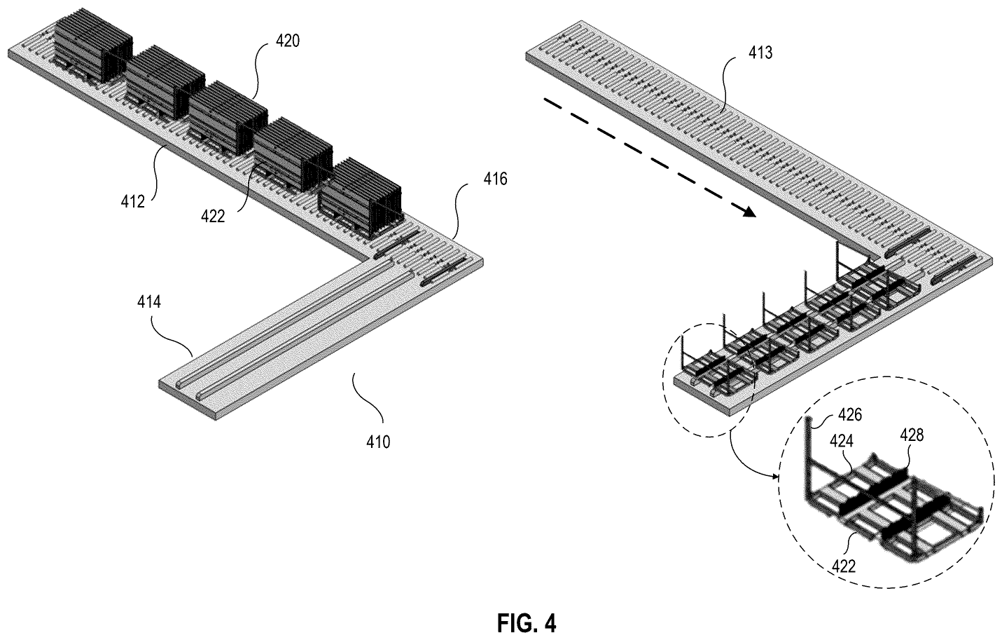

FIG. 4 depicts a pallet conveyor as a panel conveyor in accordance with various embodiments of the invention. Solar module pallets 420 are loaded onto slippers 422 for conveyance. The pallet conveyor 410 can be an L-shaped conveyor (or a U-shaped, or a linear conveyor) comprising a first section 412 to convey loaded slippers or module crates for table assembly and a second section 414 to dispatch empty slippers or empty crates. The pallet conveyor allows for the assembly factory 200 to operate automatically for an extended period without the need for re-loading of solar modules. The pallet conveyor 410 may comprise multiple rollers 413 (or a conveyor belt or similar conveyance) that are operated to automatically move in loaded slippers into a pick station 416 (which may be located at a proximal end of the first section 412) and move out empty slippers once the loaded slippers are depleted of modules.

The slipper 422 is an interface between the crate/pallet and the conveyor. The slipper 422 comprises a slipper base 424, a back support 426, and a pair of base supports 428 that are placed on the slipper base 424 for direct support of a module pallet 420. The slipper base 424 may be slanted slightly such that the module pallet 420 may lean against the back support 426 for pallet stability. The pair of base supports 428 may also comprise multiple grooves such that each solar module is supported on a corresponding groove. The pair of base supports 428 may be made of semi-rigid or elastic materials, such as rubber, to minimize impact to the module pallet 420.

In one or more embodiments, the pallet conveyor may have the capacity to hold multiple full slippers and multiple empty slippers. When a slipper at the pick station 416 is emptied, the empty slipper and a newly loaded slipper may be moved simultaneously, reducing the awaiting time of the system and thus improving operation efficiency.

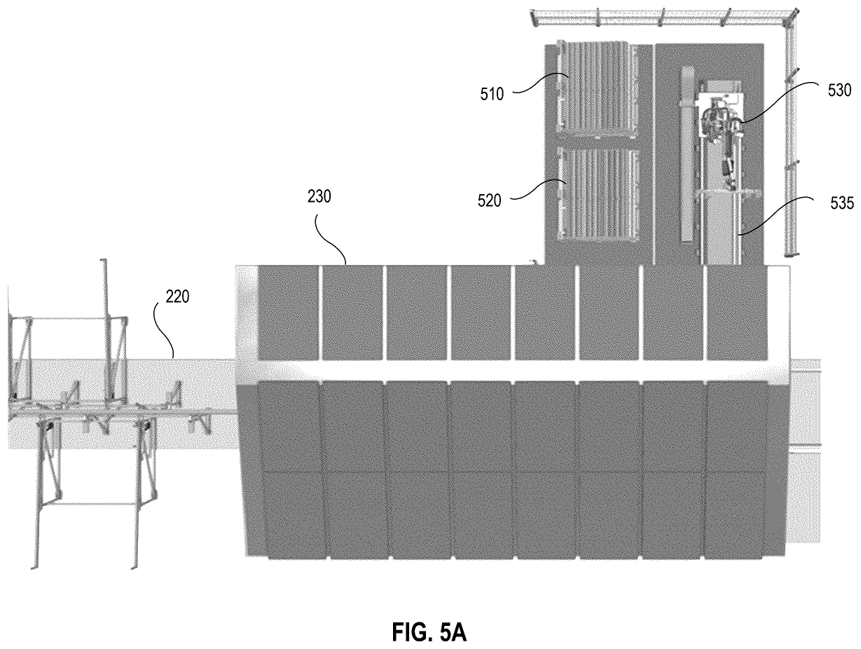

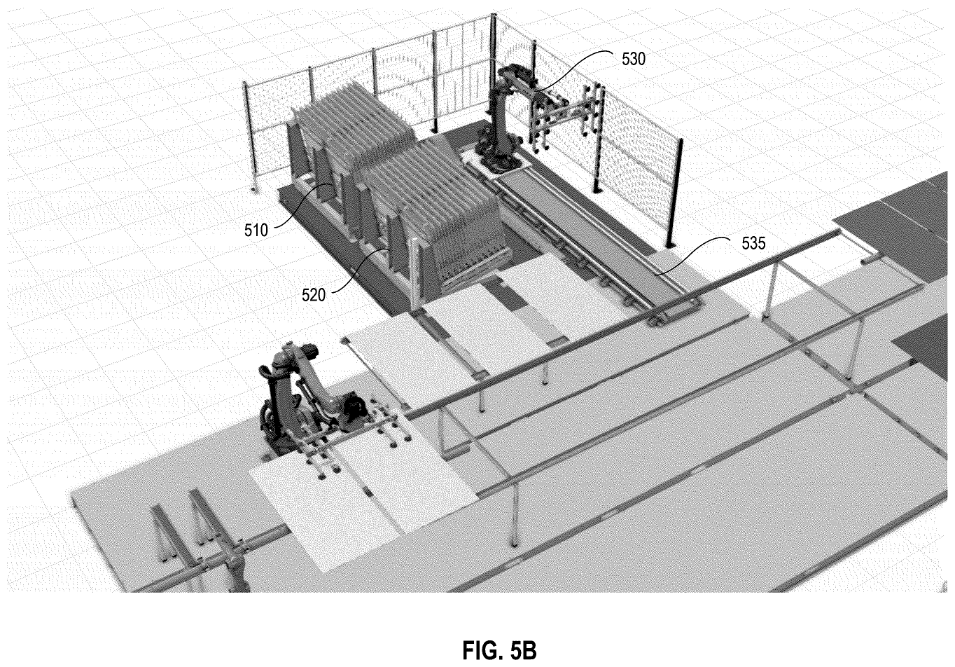

Instead of a pallet conveyor, a static pallet station may be used as a panel conveyor as shown in FIG. 5A and FIG. 5B. The static pallet station may comprise one or more pallet docks, e.g., a first dock 510 and a second dock 520, as shown in FIG. 5A and FIG. 5B, to receive loaded slippers. The term “dock” is defined as a place for loading of slippers with solar module pallets and unloading of solar modules from the pallets. A robot 530 deployed on a rail 530 may slide to a desired pick position to fetch a solar module from the slipper and deliver the fetched module to the table assembly station 230. The dual-dock configuration has a smaller footprint than the pallet conveyor shown in FIG. 4. It can still enable continuous module picking operation as long as the empty slipper is re-loaded while the robot 530 fetches solar modules from the other slipper. It shall be noted that although the robot 530 shown in FIG. 5B is deployed on the rail 535, the robot 530 may or may not need a rail dependent on the geometry and the reach of the robot.

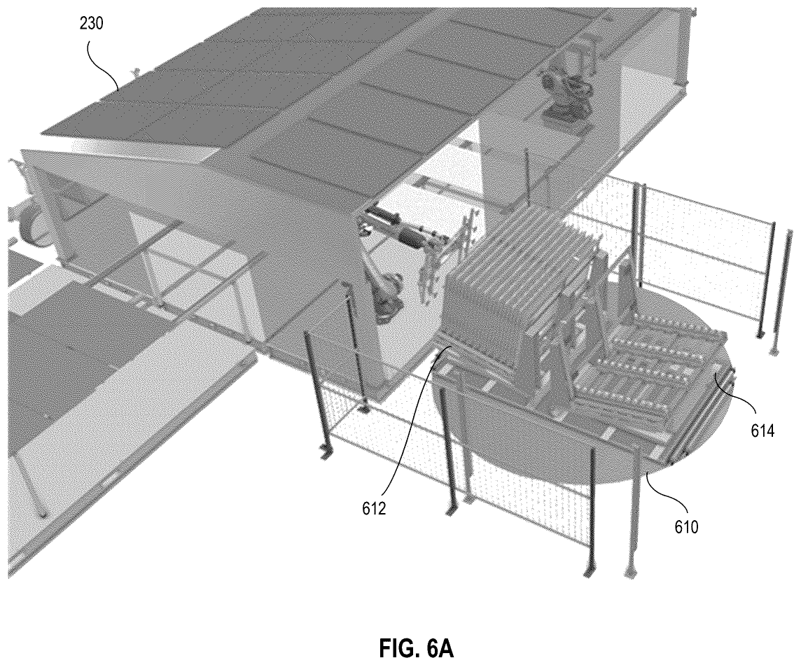

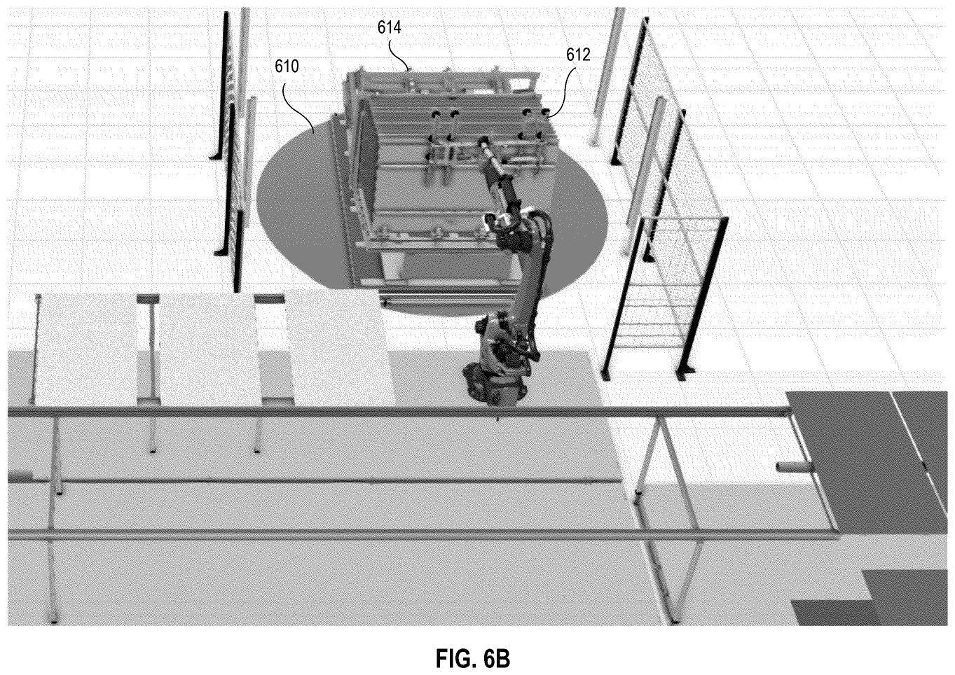

FIG. 6A depicts a rotary table as a panel conveyor and FIG. 6B depicts such a rotary table in a factory with roof structure hidden in accordance with various embodiments of the invention. Multiple slippers are placed on a rotary table 610 instead of docked side by side as shown in FIG. 5B. The rotary table 610 rotates to place a first slipper 612 with a full module pallet toward the assembly factory 200 for a robot to fetch solar modules. In the meantime, a second slipper 614 with an empty module pallet/crate/slipper is rotated away from the assembly factory 200. The second slipper 614 can be unloaded from the rotary table 610 and be replaced by a new slipper with a full module pallet. Therefore, module-loading operation may be continued without interruption. Compared to a pallet conveyor, the rotary table solution provides a smaller footprint but still maintains continuous production by slipper swapping. Although slippers are shown in embodiments in this section to provide an advantage for simplifying the interface between the crate/pallet and the conveyor, other embodiment may also be applied for loading the module crates directly on to the conveyor. The conveyor could have ramps with sloped surfaces keeping the modules from falling over. Such variations are included within the true spirit and scope of the present disclosure.

### B. Embodiments of Torque Tube Axial and Radial Positioning

Torque tubes are critical components in a solar tracking system. Torque tubes provide secure structural support for solar modules, and may be rotatable to ensure that all attached solar modules may be orientated to the Sun simultaneously for maximum photovoltaic operational efficiency. Torque tubes are typically circular, although other shapes, e.g., square, pentagonal, octagonal, or D in shape, may also be used.

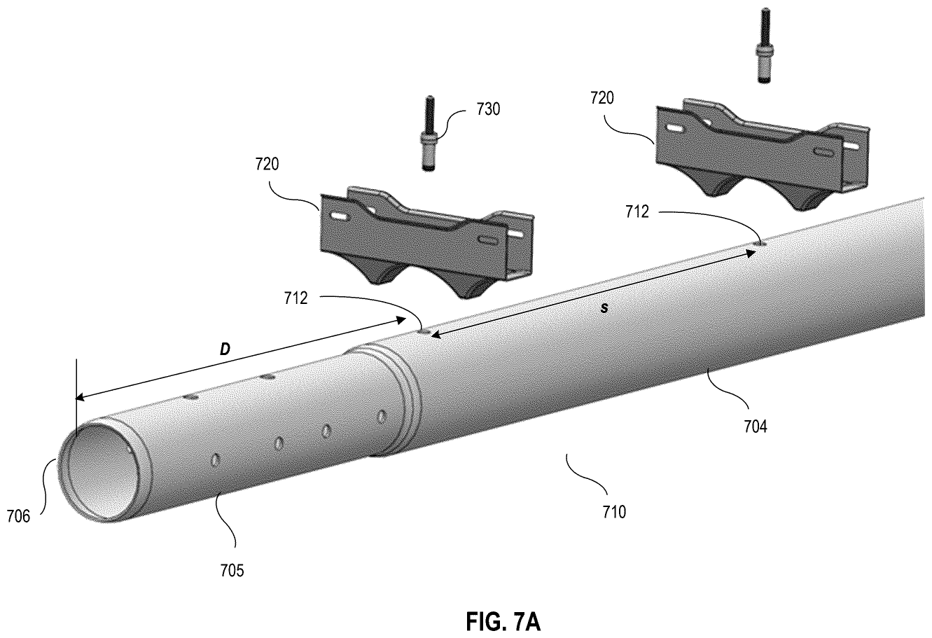

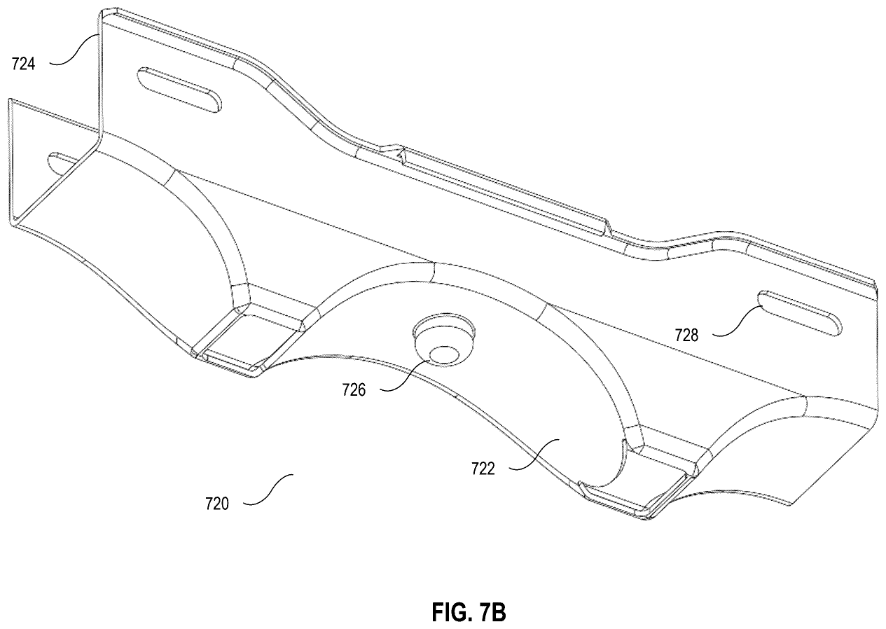

FIG. 7A depicts a perspective view of a torque tube with brackets in accordance with various embodiments of the invention. The torque tube 710 comprises a tube end 705 for tube installation on supporting piles and a tube body 704 that comprises multiple bracket holes 712 that are typically aligned and uniformly spaced (with a space s) for bracket installation. The tube end 705 is also referred to as a swaged end which has a dimeter different from the diameter of the tube body 704. The opposite end of the swaged end has the same diameter as the diameter of the tube body 704 and is referred as an unswaged end. The torque tube may have a known distance D (e.g., 644±7 mm) between a leading tube edge 706 and the nearest bracket hole (also referred to as a first bracket hole hereinafter) among the multiple bracket holes 712. Such a known distance D may be utilized for torque tube positioning.

A bracket 720, also referred to as a module interface bracket (MIB) in one or more embodiments of the present disclosure, may be securely attached to the torque tube 710 via a mounting component 730, e.g., a bolt, a screw, a rivet, etc. The bracket 720 is also the structure used to attach the rails or frames of a solar module for module installation.

FIG. 7B depicts a perspective view of a bracket in accordance with various embodiments of the invention. The bracket 720 comprises a concaved surface 722 that matches the torque tube for seamless contact, a grooved body 724 to receive purlins of a solar module. The grooved body 724 comprises multiple slots 728 for wedge locking. The concaved surface 722 may have a hole such that the mounting component 730, e.g., a bolt, a screw, a rivet, etc., may pass through to engage a bracket hole 712. Alternatively, the concaved surface 722 may have an anchor 726 to engage one bracket hole for alignment of bracket 720 onto the torque tube.

To enable automatic solar table assembly, the torque tube needs to be oriented to a desired angular position, e.g., with the multiple bracket holes facing upwards, for automatic MIB installation. Embodiments of torque tube axial and radial positioning are described hereinafter in details. The embodiments enable desired lengthwise and angular-wise movement for a torque tube for subsequent automatic installation of MIBs and solar modules. Although the bracket holes are facing upwards in embodiments of the present disclosure, one skilled in the art shall understand that the bracket holes may face other directions for alignment purpose. Such variations shall be within the true spirit and scope of the present disclosure.

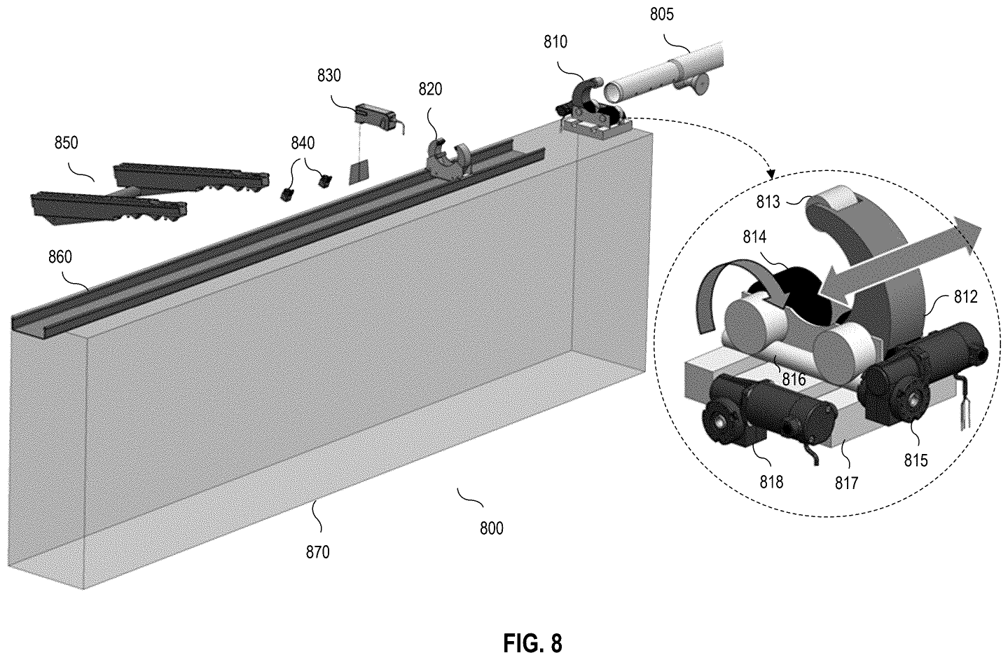

FIG. 8 depicts an overview of a torque tube positioning system in accordance with various embodiments of the invention. The torque tube positioning system 800 comprises a rotator 810, a tube clamp 820 (also referred to as an advance-clamp) slidably attached on a tube advance rail 860 that sits on a platform 870, a profiler 830, one or more proximity sensors 840, and a bracket station (also referred to as a MIB station) 850. The rotator 810 receives a torque tube 805, which is fed from the torque tube dispenser 220, and is configured to clamp the tube for micro axial direction (also referred to as north-south direction or N-S direction) and radial orientation alignment. As shown in FIG. 8, the rotator 810 comprises a clamp arm 812, a clamp roller 813 placed at a distal end of the clamp arm 812, a rotation wheel 814 for tube rotation, and a rotator base 817. The clamp arm 812 may be configured to be in an open position to let the torque tube 805 pass through, or in a closed position with the clamp roller 813 firmly pushing the torque tube 805 against the rotation wheel 814 to enable tube rotation. The rotation wheel 814 may be a worm wheel driven by a rotation motor 815 via a worm gear 816.

Furthermore, the clamp arm 812 and the rotation wheel 814 are slidably attached on the rotator base 817 such that the rotator 810 may also be capable of providing a relatively limited (e.g., 100 mm) but precise axial movement besides angular rotation (also referred to as clock positioning) for the torque tube while the clamp arm 812 is in the closed position.

The profiler 830 may be a laser profiler that emits a laser beam 832 (a visible laser or an infrared laser) onto the torque tube. The laser beam is reflected off the tube surface and captured by a sensor within the profiler to generate a profile. When the laser beam 832 falls into a bracket hole 712, the reflection is significantly different. Therefore, the laser profiler is able to precisely locate the bracket hole 712. Although a laser profiler is shown on some of the figures, one skilled in the art shall understand that other types of profilers, such as a camera-based or ultrasound profiler, may also be used for torque tube radial positioning.

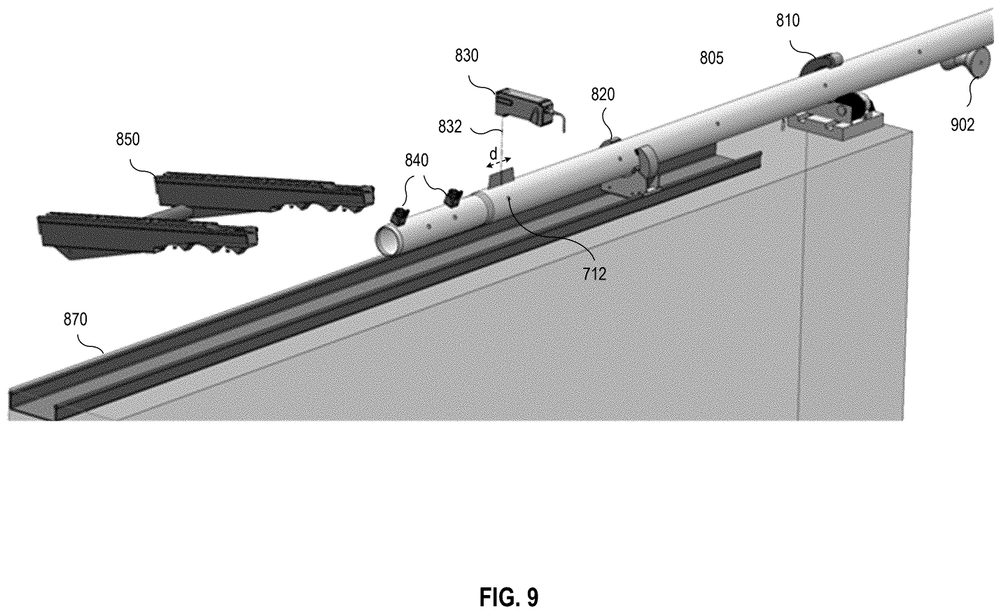

FIG. 9 graphically depicts a process for torque tube axial alignment in accordance with various embodiments of the invention. The torque tube 805 is first fed from the torque tube dispenser 220 by one or more feeding rollers 902 to partially pass through the rotator 810 and the tube clamp 820, as shown in FIG. 9. The one or more proximity sensors 840 indicate when to stop the one or more feeding rollers 902 such that the torque tube 805 may be stopped with the first bracket hole longitudinally within a scanning range d (e.g., 150 mm) of the profiler 830. For example, one proximity sensor 840 may be placed away from the profiler with a distance the same as the distance D. When this proximity sensor detects the torque tube, the sensor sends a signal to the rollers 902 such that the torque tube may be stopped at a first location where the first bracket hole longitudinally within the scanning range d, although the angular or clock position is unknown at this stage.

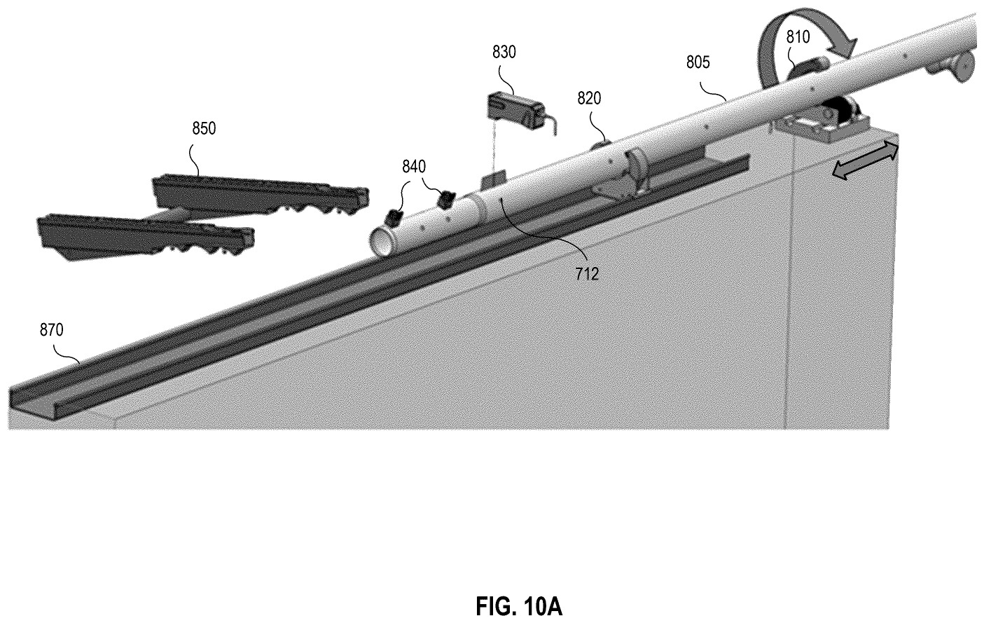

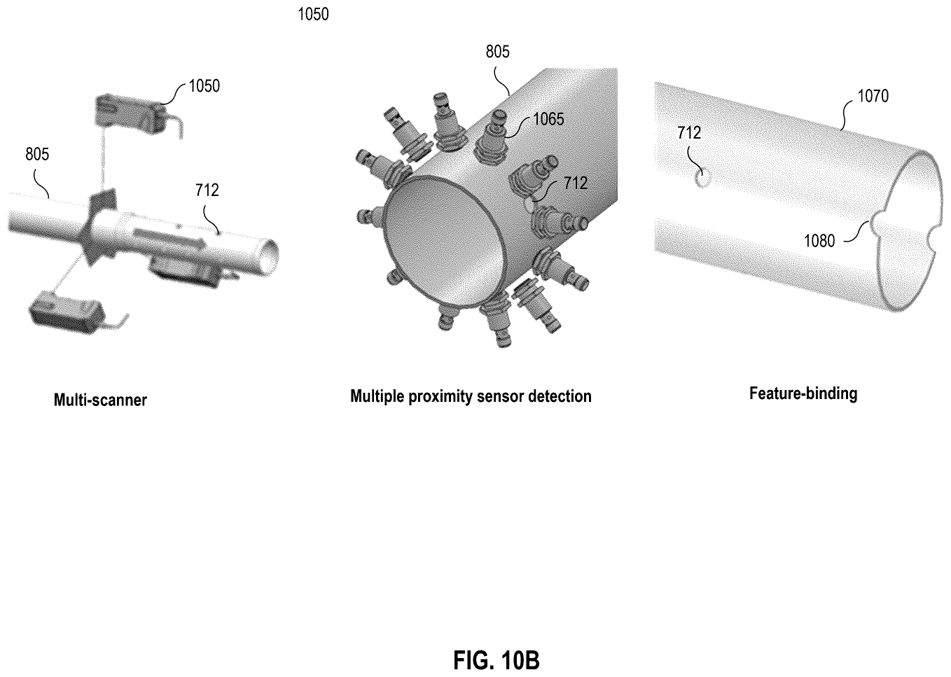

FIG. 10A graphically depicts a process for torque tube orientation alignment in accordance with various embodiments of the invention. After the torque tube is stopped at the first location, the rotator 810 is configured to have the clamp arm 812 in a closed position with the clamp roller 813 firmly pushing the torque tube 805 against the rotation wheel 814 to rotate the torque tube while the profiler 830 performs a scan, as shown in FIG. 10A. In one or more embodiments, the rotator 810 may also apply an axial movement besides an angular rotation for the torque tube such that the torque tube is at a position with determined angular orientation and axial position (e.g., the first bracket hole centered on top and right below the profiler 830).

FIG. 10B graphically depicts alternative approaches for torque tube orientation alignment in accordance with various embodiments of the invention. In a multi-scanner approach, multiple scanners 1050, instead of a single scanner shown in FIG. 10A, may be used to scan the torque tube 805 to quickly locate a bracket hole 712. Since orientation of the multiple scanners is known, a detection of the bracket hole 712 by any one of the multiple scanners would be adequate to determine the radial orientation of the torque tube and, thus a desired radial alignment to be performed. The multiple scanners may be arranged uniformly around the torque tube, such as in a triad arrangement, as shown in FIG. 10B.

Alternatively, a plurality of proximity sensors 1065, with the orientation of each proximity sensor known, are placed circularly around the torque tube to detect the bracket hole 712 and thus the radial orientation of the torque tube. Similar to the multi-scanner approach, the plurality of proximity sensors may shorten the search time to locate the radial position of the bracket hole for a quicker radial alignment process. Alternatively, an internal light, e.g., a visible LED light, an infrared light, etc., may be placed within the torque tube 805 after its axial position is located and aligned. A plurality of light detection sensor may be placed around the torque tube to detection light through the bracket hole 712 and thus the radial orientation of the torque tube.

Alternatively, a torque tube may incorporate additional features that may be utilized to determine the radial position of the bracket hole. For example, the torque tube 1070 may have an edge groove 1080 that is radially oriented the same direction of the bracket hole 712. Instead of searching the orientation of the bracket hole 712 directly, orientation information of the edge groove 1080 may be used to determine the radial position of the bracket hole 712.

It shall be noted that the abovementioned approaches may be used individually or in combination for faster and more efficient radial positioning and alignment. It is intended that all permutations, enhancements, equivalents, combinations, and improvements thereto that are apparent to those skilled in the art upon a reading of the specification and the drawings are included within the scope of the present disclosure.

### C. Embodiments of Bracket and Module Installation onto a Torque Tube

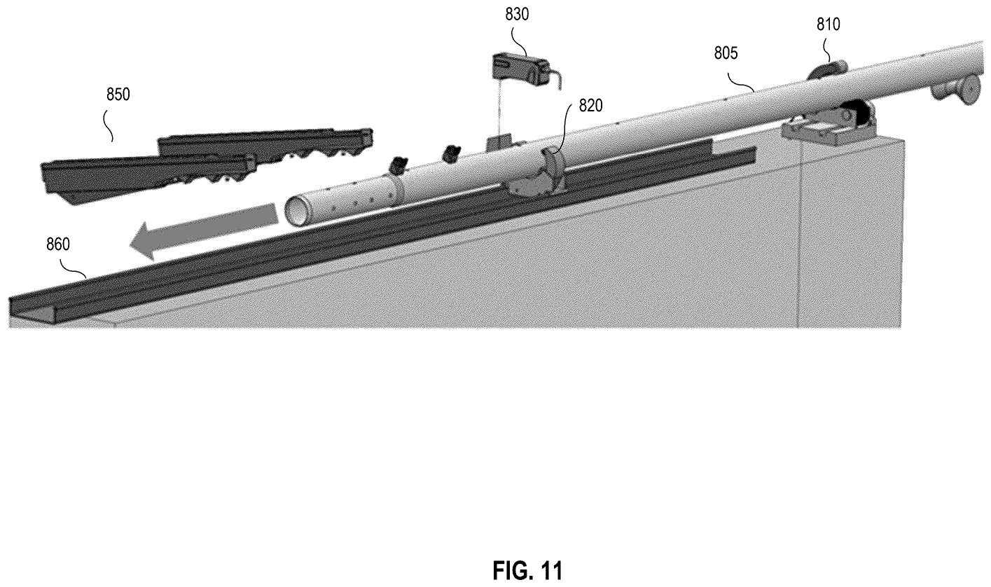

As shown in FIG. 11, after axial position and radial orientation of the torque tube is settled, the rotator 810 opens the clamp arm 812 to release the torque tube. The tube clamp 820 locks the torque tube 805 and slides along the tube advance rail 860 to move the torque tube in a first distance toward the MIB station 850. The first distance is the same as the distance between the MIB station 850 and the profiler 830.

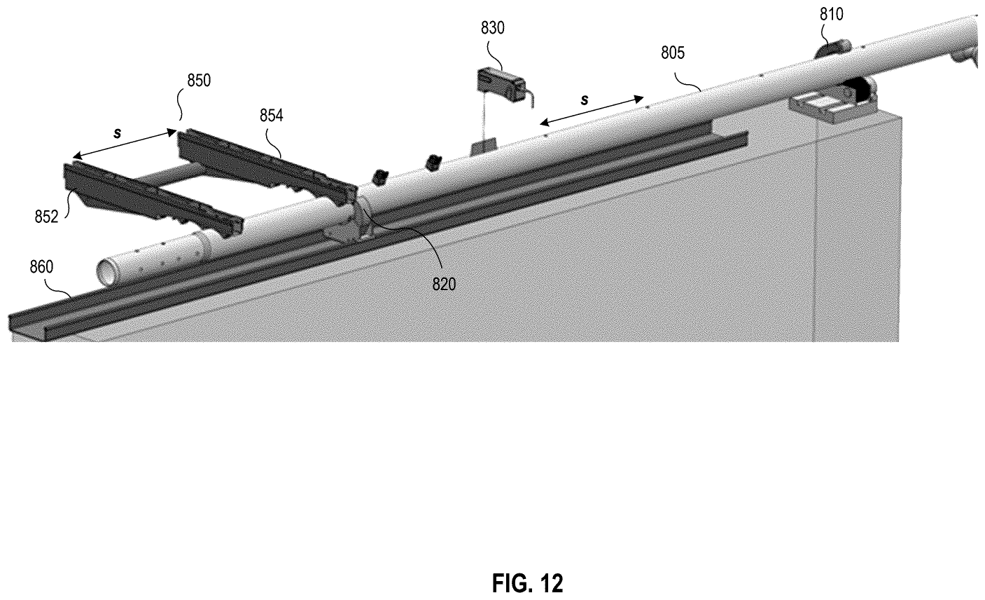

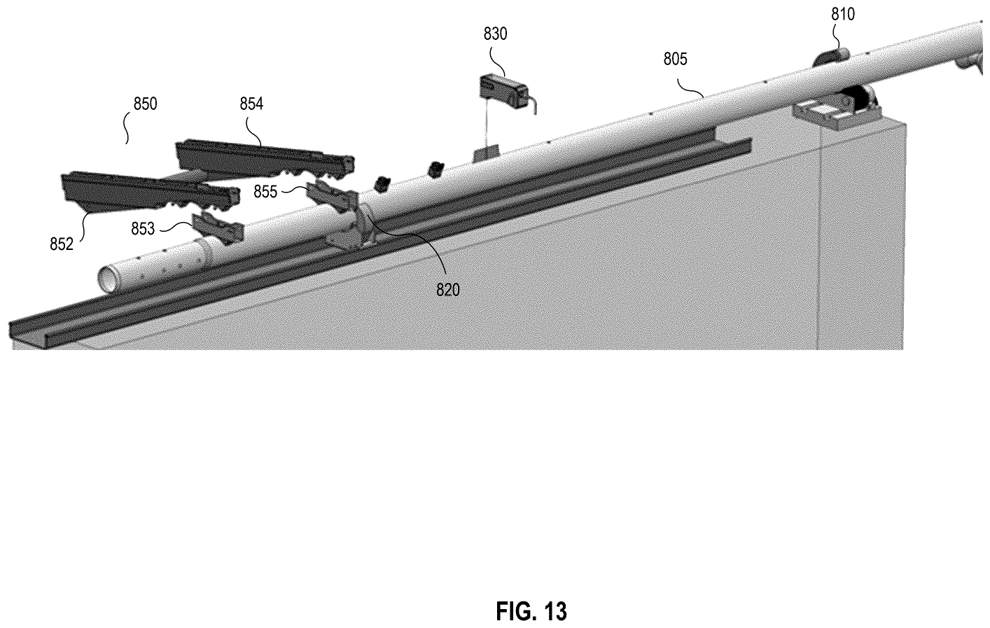

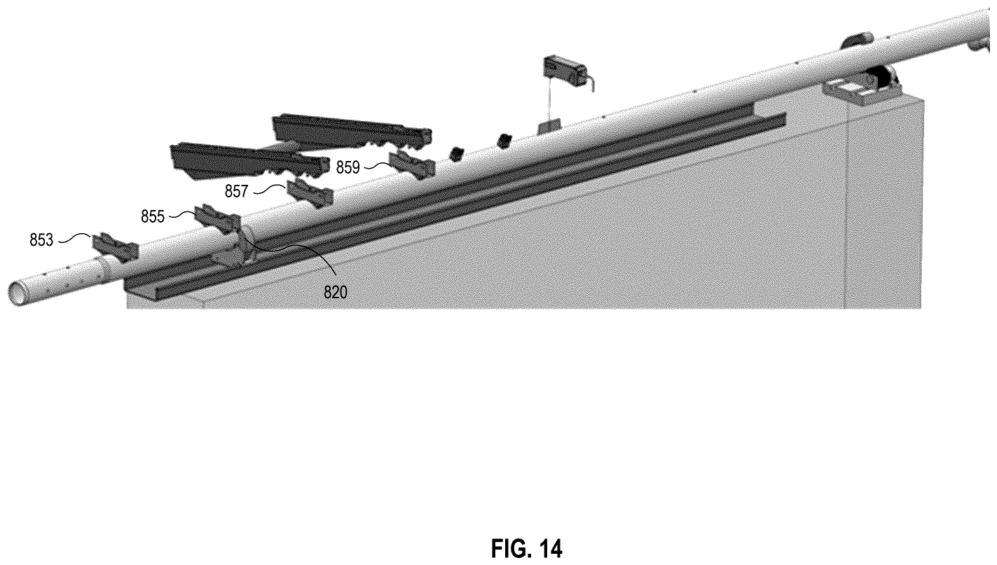

FIGS. 12-14 graphically depict a process for automatic bracket installation onto a torque tube in accordance with various embodiments of the invention. The MIB station 850 may comprise one or more arms to land and attach brackets (e.g., brackets 853/855) to the torque tube. As shown in the exemplary embodiment of FIG. 12, the MIB station 850 comprises a first arm 852 and a second arm 854, which are spaced with the same space s as bracket hole spacing and operate in parallel for higher efficiency for bracket attaching operation. Once landed on the torque tube, the brackets are automatically attached to the torque tube 805 via a bolt, a screw, a rivet, etc. Afterward, the tube clamp 820 slides along the tube advance rail 860 for a second distance (which is the same as the space s) for the MIB station 850 to perform a subsequent attaching operation (e.g., for brackets 857/859). Such a process of torque tube moving and bracket attachment may continue until all bracket holes of the torque tube are filled and automatically resume for a subsequent torque tube.

Depending on the length of the tube advance rail 860, the tube clamp 820 may slide forward from a start position until all bracket attaching operations are completed for the torque tube, and then slide back to the start position again for a subsequent torque tube. Alternatively, the tube clamp 820 may slide forward from a start position for a first bracket-attaching operation (or first few bracket-attaching operations) and then slide backward to the start position for a subsequent bracket-attaching operation, etc.

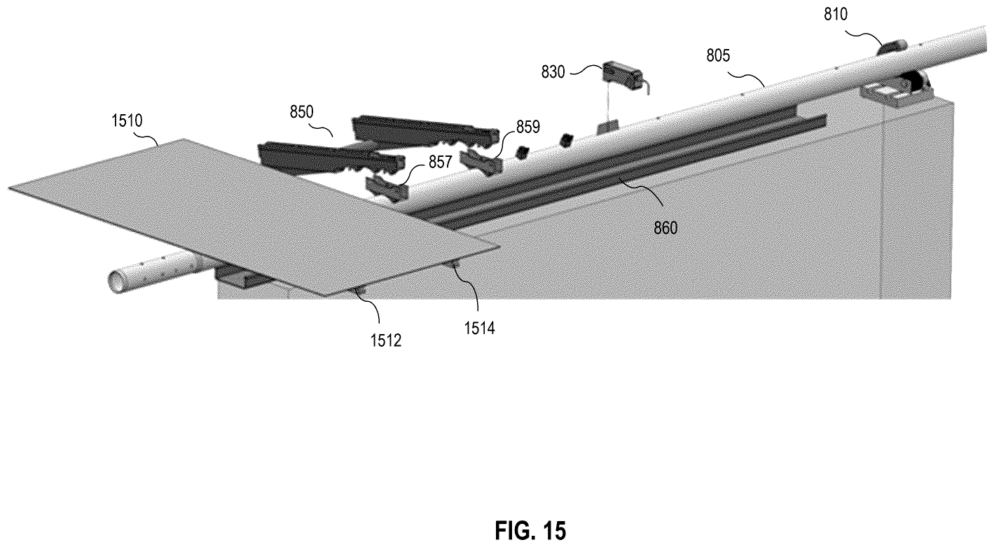

Once the brackets are securely attached to the torque tube, a solar module may be installed onto the attached brackets. In one or more embodiments, installation of a solar module and attachment of brackets may be implemented in parallel, as shown in FIG. 15. When the torque tube 805 has brackets 853/855 installed and proceeds to a position for installation of brackets 857/859, a solar module 1510 may be attached in parallel with module purlins 1512/1514 engaged to the brackets 853/855 (not shown in FIG. 15). Such parallel operations of bracket and solar model installation further increases solar table assembly efficiency.

### D. Embodiments of Automatic Solar Module Feeding

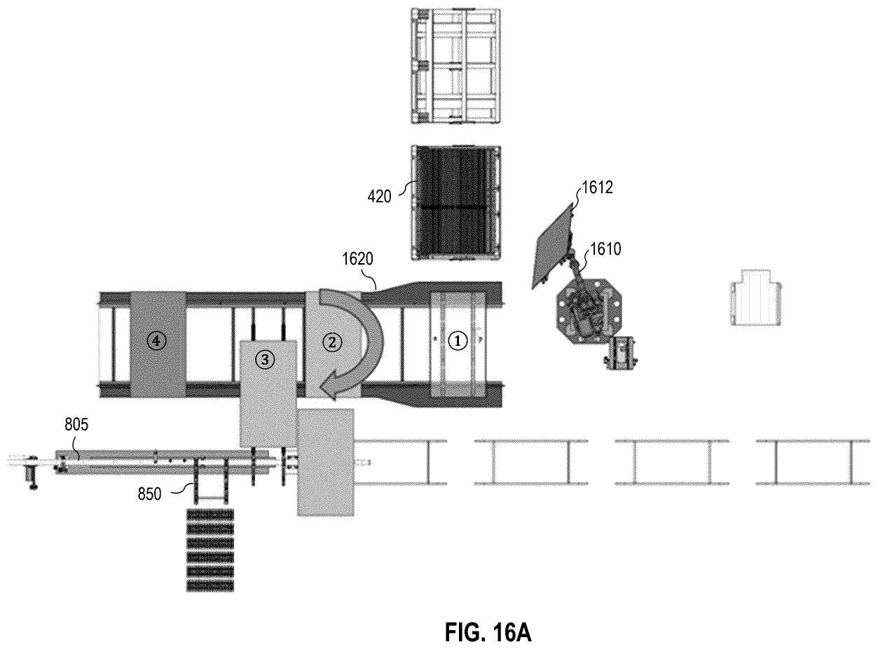

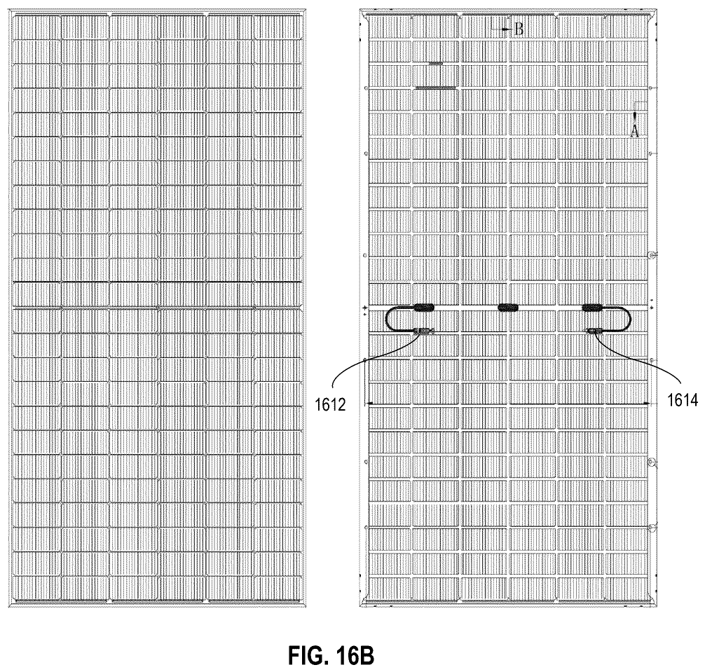

FIG. 16A depicts a top-down view of loading solar modules from the module pallet to the QC/inspection conveyor 1620 and on to the mounting position on the torque tube/module interface rails in accordance with various embodiments of the invention. A robot 1610 fetches a solar module 1612 from a solar module pallet 420 and blindly places the fetched solar module on a module conveyor 1620 where a toothed chain/conveyor interfaces with the frames of the solar module to align and advances the solar module to an inspection station, as shown in step \textcircled{1} in FIG. 16A. The inspection station may be located between \textcircled{1} and \textcircled{2} shown in the figure and configured to perform inspection/QC for solar module(s). The inspection/QC area can be expanded to accommodate multiple inspections or if some inspections takes more time than the robot pick time.

Afterward, the position of the solar module is scanned, as shown in step \textcircled{2} in FIG. 16A. If the solar module needs to be rotated (e.g., from a traverse position into a longitudinal or N-S orientation), the solar module is raised and rotated. The rotation is to orient the module to a correct polarity in the N-S direction to match the polarity of the tracker. A solar module may have a positive connector 1612 on one side and a negative connector 1614 on the opposite side, as shown in FIG. 16B. Since the tables are inserted towards a slew drive/motor which is situated in the middle of the row, the modules on tables to one side of the motor need to have their positive connectors pointing towards the swaged end of the tables and away from the swaged end of the tables on the other side of the motor. Different options may be used for solar module scanning. For example, a barcode scan may be used to identify each module and where it needs to be installed on the solar site, through manufacturing execution system (MES) software. Scanning a barcode of a solar module can validate whether the orientation of the module is correct. The barcode may be generally placed on one end of the module. If the solar module is improperly oriented, the barcode will not be in the expected location and the solar module needs to be rotated correctly. The rotation is mainly done to ensure that the solar modules have the correct polarity with respect to N-S direction. A quality scan may also be used for scanning for module damage, cracked glass, etc.

Solar modules that pass quality control (QC) check are staged for assembling onto MIBs, as shown in step \textcircled{3} in FIG. 16A. The QC check may be a visual check, using a camera and automatic image recognition/analysis algorithm, for possible damaged or distorted cell, cracked or chipped front/backside glass, damaged back sheet or frame, etc. Solar Modules that do not pass QC check are advanced to a different position for off-loading from the assembling process, as shown in step \textcircled{4} in FIG. 16A.

### E. Embodiments of Automatic Solar Table Assembly

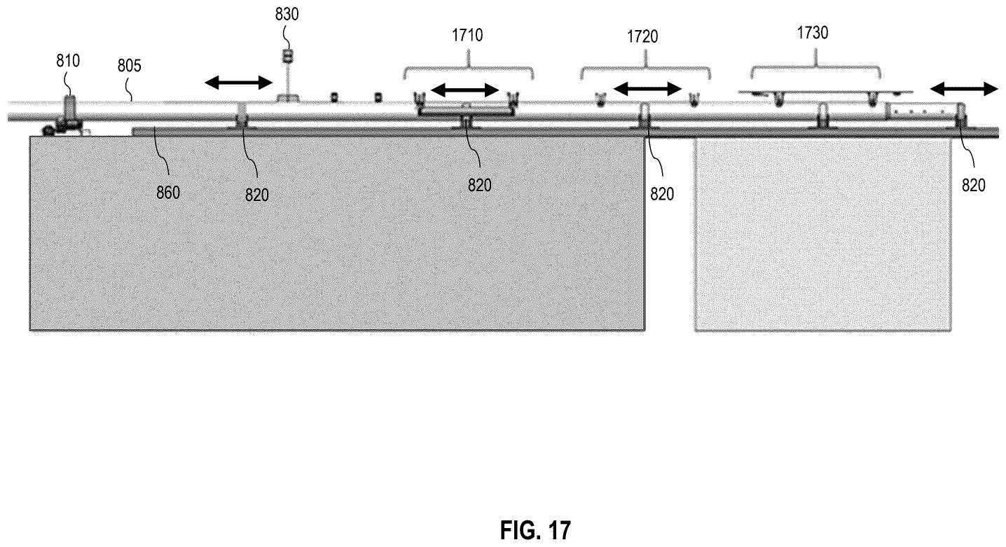

FIG. 17 depicts a side view of automatic solar table assembly process in accordance with various embodiments of the invention. As shown in FIG. 17, multiple tube clamps 820 may be used for a more balanced support of the torque tube 805. The tube clamps may or may not work in synchronization. When the torque tube 805 needs to advance, the rotator 810 releases the torque tube, and the multiple tube clamps 820 lock the torque tube and slide synchronically along the tube advance rail 860 to move the torque tube forward. The tube clamps 820 may slide forward with a forward range (e.g., 1240 mm) and backward with a backward range (e.g., 199 mm). It shall be noted that the tube clamps 820 may be grouped into a first set of tube clamps and a second set of tube clamps to perform different operations, e.g., engaging at different times or even engaging different tubes. For example, the first set of rail clamps grabs a torque tube and advances it while the second set of rail clamps is not engaged. The first set of rail clamps moves a prescribed distance to a next location where the second set of rail clamps engages and the first set of rail clamps releases and slides back along the tube advance rail 860 to the original position. The second set of rail clamps holds the torque tube in place until the first set of tube clamps slides back and takes over, Afterwards, the second set of rail clamps releases and returns to their original position.

Automatic solar table assembly comprises multiple stages, e.g., a torque tube positioning stage as described in Section B, a bracket installation stage (also referred to as a MIB stage) 1710, a module attachment stage 1720, and a lock stage 1730 to securely lock the attached solar module. Finished solar table is advanced with enough clearance (e.g., at least double of the forward range of the rail clamps) to prevent interference to operations of subsequent torque tubes. In one or more embodiments, the lock stage 1730 may be a wedge stage to automatically and securely lock the attached solar module using one or more wedges. The module attachment stage 1720 and the lock stage 1730 may be at the same station (location) dependent on layout and cycle time of each of the stages. In one or more embodiments, the solar modules may be framed modules for a solar table, a module support bracket is installed on a last solar module near a swaged end of the torque tube and the lock stage 1730 may be a stage for rivet/bolt&nut installation instead of a wedge stage.

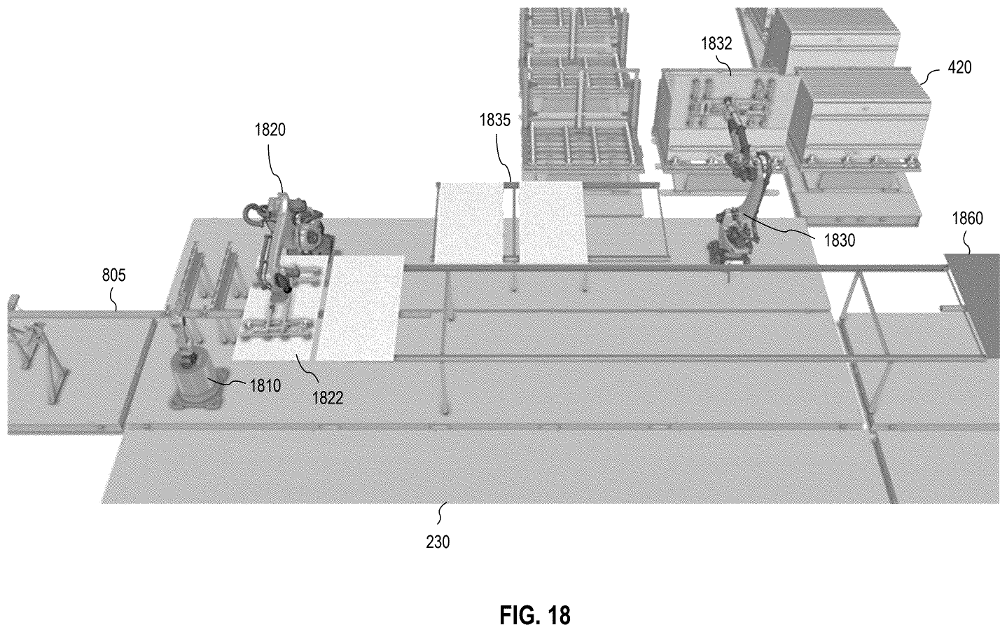

FIG. 18 graphically depicts a process for automatic solar table assembly in accordance with various embodiments of the invention. The automatic solar table assembly may be performed in the table assembly station 230 with the involvement of multiple robots. A torque tube 805 fed from the torque tube dispenser 220 is handled, after tube orientation positioning, by a first robot 1810 for attaching MIBs. Afterward, a second robot 1820 installs a solar module 1822 on the attached MIBs. Assembled solar tables 1860 are dispatched from the table assembly station for storage or transportation. A third robot 1830 fetches a solar module 1832 from a solar module pallet 420 and lays down the fetched solar module onto a module conveyor 1835 for the second robot 1820 to pick up.

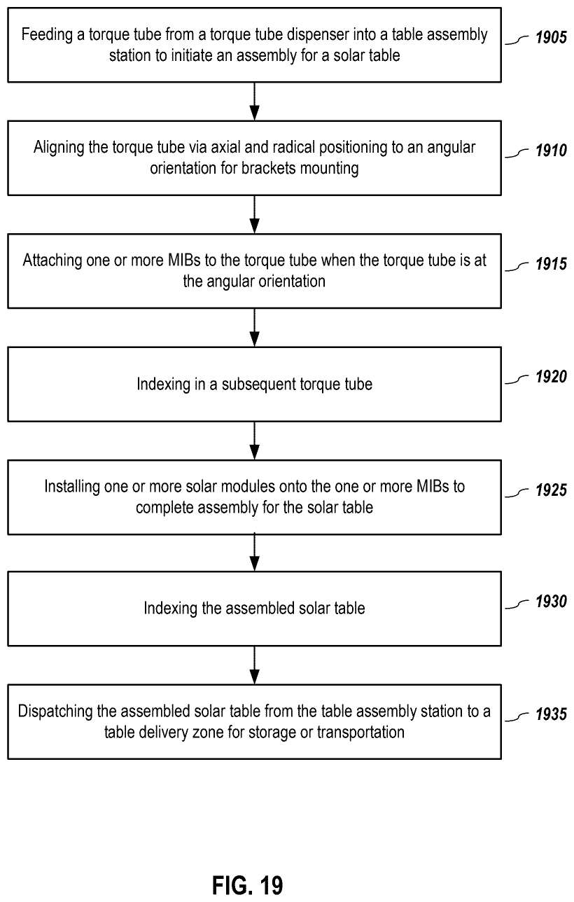

FIG. 19 depicts a process for automatic solar table assembly in accordance with various embodiments of the invention. In step 1905, a torque tube is fed from a torque tube dispenser into a table assembly station to initiate an assembly for a solar table. In step 1910, the torque tube is aligned via axial and radial positioning to an angular orientation for brackets mounting. In step 1915, one or more MIBs are attached to the torque tube when the torque tube is at the angular orientation. In step 1920, a subsequent torque tube is indexed in such that a subsequent tube alignment may be implemented while the torque tube attached with MIBs is indexed out for solar module installation.

In step 1925, one or more solar modules are installed onto the one or more MIBs to complete assembly for the solar table. The one or more solar modules may be fetched from modules placed on a module conveyor and installed onto the MIBs. The modules on the module conveyor are fetched by a robot from a module pallet, laid on the module conveyor, oriented in a north-south (N-S) direction, and passed a QC check for installation on the one or more MIBs. In one or more embodiments, MIB attaching and module installation may be implemented in parallel for improved efficiency. In one or more embodiments, in cases framed modules being used for a solar table, a module support bracket is installed on a last solar module near a swaged end of the torque tube. In one or more embodiments, A BHA is also installed to support the last solar module near an un-swaged end of the torque tube.

The steps of 1920 and 1925 may be implemented in parallel for higher assembly efficiency. In step 1930, the assembled solar table is indexed for assembling records. In step 1935, the assembled solar table is dispatched from the table assembly station to a table delivery zone for storage or transportation.

### F. Embodiments of Assembled Solar Table Storage for Delivery

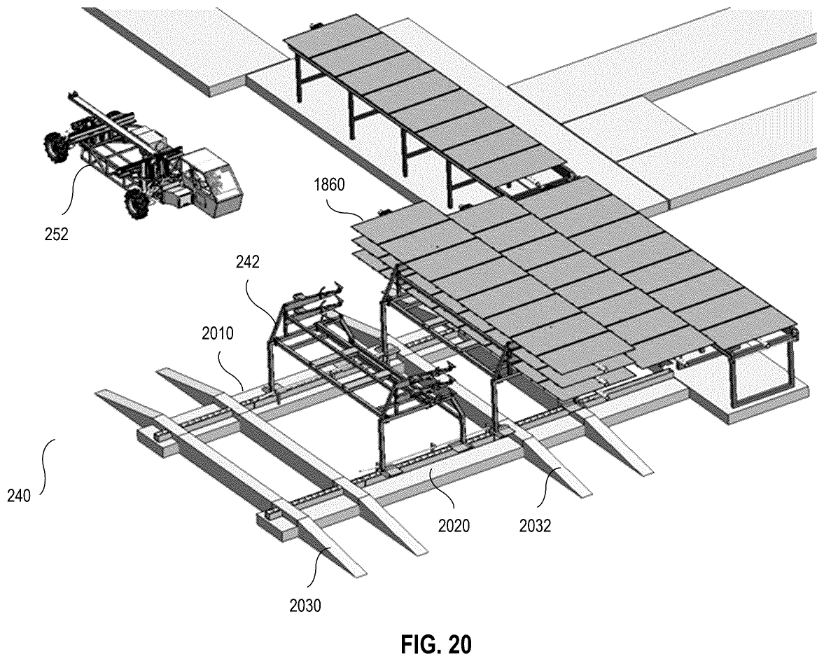

FIG. 20 depicts a perspective view of loading assembled solar tables onto table racks in accordance with various embodiments of the invention. Assembled solar tables are dispatched automatically from the table assembly station to the table delivery zone 240, where the solar tables 1860 may be stacked onto a solar table rack 242 or delivered directly to a transport/landing vehicle 252.

In one or more embodiments, the solar table rack 242 is able to hold multiple assembled solar tables and is slidable along a pair of rack rails 2010/2020. Once the solar table rack 242 is fully loaded with assembled solar tables, the solar table rack 242 may slide toward an unloading area 2030 where the motorized vehicle 252 may park underneath to off-load a solar table or even take the entire solar table rack 242 for delivery. The unloading area 2030 may also be the place where a transport vehicle 252 drops an empty solar table rack onto the rails for solar table re-loading. As shown in FIG. 20, multiple unloading areas (e.g., 2030/2032) may be placed along the rack rails to allow parallel solar table rack dropping and/or unloading operations.

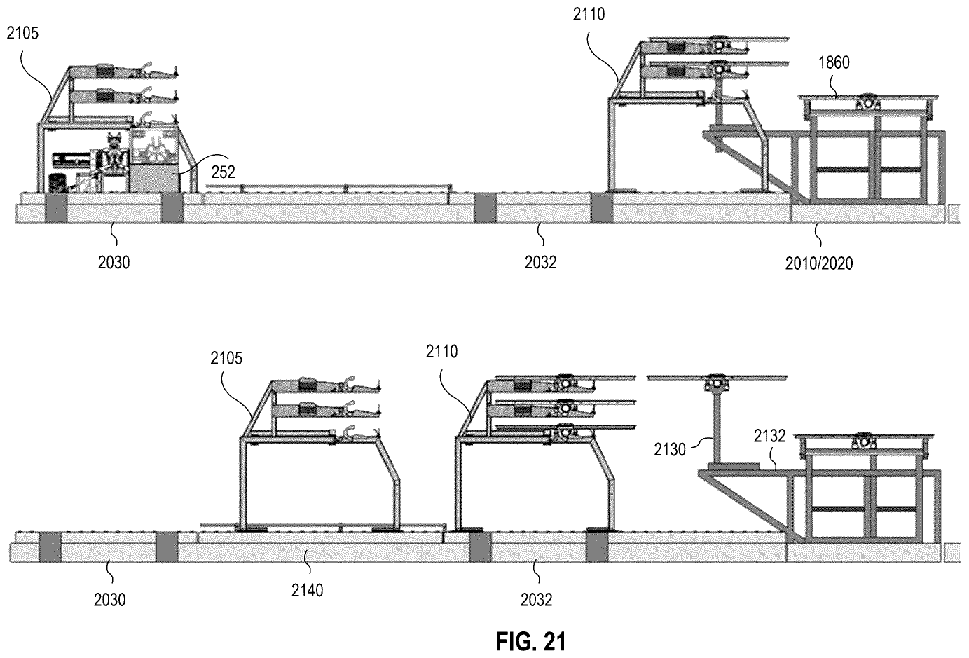

FIG. 21 depicts a front view of loading an assembled solar table onto a mobile vehicle for delivery in accordance with various embodiments of the invention. An assembled solar table 1860 is dispatched from the table assembly station and picked up by a loader 2130 that is slidable on a loader frame 2132. The loader 2130 stacks the solar table 1860 onto a solar table rack 2110. The loader 2130 may be height-adjustable for solar table loading into rack slots of different heights.

Once fully stacked, the solar table rack 2110 slides along the rack rails 2010/2020 to an unloading area 2032 for rack picking up by a motorized vehicle. In the meantime, an empty solar table rack 2105 may be dropped by a motorized vehicle 252 to another unloading area 2030. The solar table rack 2105 slides along the rack rails 2010/2020 to a staging area 2140, waiting for solar table re-loading.

Such a configuration of rack loading with multiple unloading areas for table delivery zone allows a high-capacity buffer zone for table rack loading and uninterrupted solar table assembly. Furthermore, the multiple unloading areas accommodate parallel solar table rack dropping and loading, thus further improving solar table delivery efficiency.

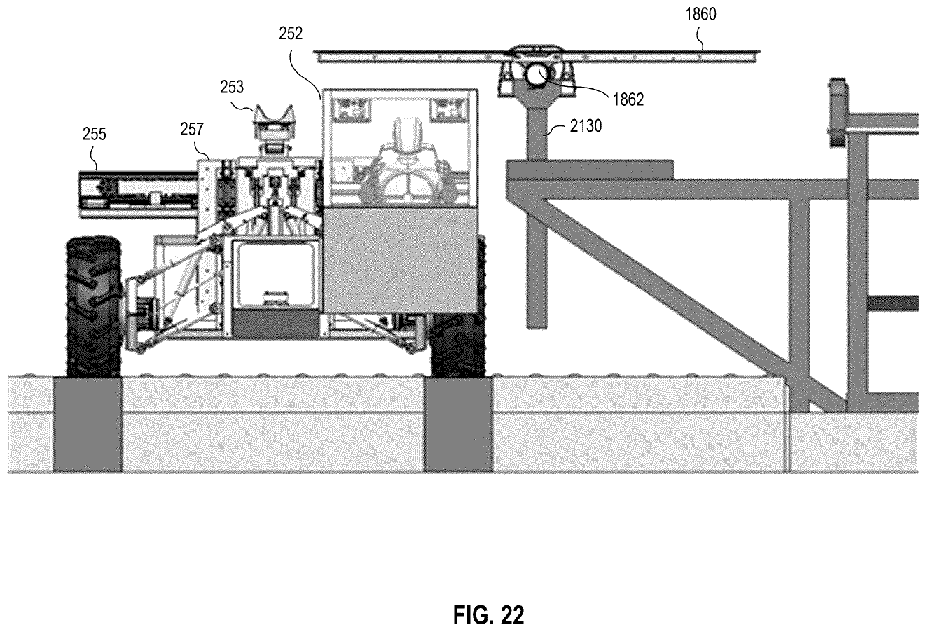

In one or more embodiments, due to various restrictions such as factory size, a table delivery zone may have a compact layout without rack loading. Instead, assembled solar tables are directly loaded onto a transport vehicle for delivery. FIG. 22 depicts a side view of loading an assembled solar table onto a mobile vehicle for delivery in accordance with various embodiments of the invention. Such a setup may be great for sites where distance to a central factory is short and dense transportation is not needed from solar table racks.

As shown in FIG. 22, the loader 2130 may load an assembled solar table 1860 directly onto a holder 253 of a transport vehicle 252. The holder 253 may be moved horizontally by a side-shift element 255 and vertically by a height-shift element 257 for position alignment to receive the solar table 1860 from the loader 2130. Afterward, the motorized vehicle 252 transports the solar table 1860 for on-site installation and comes back for re-loading. The handoff process may be automated, manual, or a combination of the two. The loading process may be a combination of movements of the loader and the height/side-shift elements on the transport vehicle. For example, the solar table 1860 may be presented above the transport vehicle 252. Then the transport vehicle 252 moves vertical and horizontal actuators to hold the torque tube 1862 of the solar table 1860. Afterwards, the loader 2130 releases the solar table 1860 and moves out of the way.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently, including having multiple dependencies, configurations, and combinations.

What is claimed is:

1. A method for automatic solar table assembling comprising:
feeding a torque tube from a torque tube dispenser into a table assembly station to initiate an assembly for a solar table, the torque tube comprises a plurality of bracket holes;
aligning the torque tube via axial and radial positioning to an angular orientation for brackets mounting;
attaching one or more brackets to the torque tube when the torque tube is at the angular orientation;
installing one or more solar modules onto the one or more brackets to complete assembly for the solar table; and
dispatching the assembled solar table from the table assembly station to a transport vehicle directly or a table delivery zone.

2. The method of claim 1, wherein aligning the torque tube comprises steps of:
detecting, using one or more proximity sensors, an axial position of the torque tube;
stopping the torque tube at a first location where a first bracket hole among the plurality of bracket holes is longitudinally within scanning range of a profiler;
rotating, by a rotator, the torque tube while the profiler performs a scan to locate the first bracket hole such that the torque tube is oriented to the angular orientation for brackets mounting.

3. The method of claim 2, wherein aligning the torque tube comprises steps of:
locking, by a tube clamp, the torque tube after the torque tube is oriented to the angular orientation; and
sliding the torque tube along a tube advance rail to move the torque tube toward a bracket station for attaching the one or more brackets.

4. The method of claim 1, wherein aligning the torque tube comprises steps of:
detecting, using a plurality of proximity sensors placed circularly around the torque tube with orientation of each proximity sensor known, a first bracket hole and thus a radial orientation of the torque tube;
rotating, by a rotator, the torque tube to the angular orientation for brackets mounting.

5. The method of claim 1, wherein at least part of attaching one or more brackets and part of installing one or more solar modules are implemented in parallel.

6. The method of claim 1, wherein the one or more solar modules are obtained using steps comprising:
fetching, by a robot, solar modules, from one or more module pallets;
laying the fetched solar modules on a module conveyor where the fetched solar modules are aligned and advanced to a scan station;
rotating one or more fetched solar modules if the one or more fetched solar modules need to be rotated after a scan; and
staging solar modules passing quality control (QC) check for assembling onto the one or more brackets.

7. The method of claim 6, wherein one or more module pallets are placed on a static pallet station, a rotary table, or a pallet conveyor that comprises a first section to convey loaded slippers for table assembly and a second section to dispatch empty slippers.

8. The method of claim 1, wherein the assembled solar table is dispatched from the table assembly station to the table delivery zone for stacking onto a solar table rack that is capable of holding multiple assembled solar tables.

9. The method of claim 8, wherein the solar table rack is slidable on a rack rail, once the solar table rack is fully loaded, the solar table rack slides along the rack rail to an unloading area for rack picking up by a transport vehicle for on-site installation.

10. The method of claim 9, wherein the rack rail is able to receive an empty solar table rack for solar table re-loading.

11. A system for automatic solar table assembling comprising:
a torque tube dispenser that feeds a torque tube, the torque tube comprises a plurality of bracket holes;
a table assembly station that receives the torque tube to implement automatic assembly for a solar table, the table assembly station comprises:
a torque tube positioning stage that aligns the torque tube via axial and radical positioning for brackets mounting;
a bracket installation stage that attaches one or more brackets to the torque tube when the torque tube is at the angular orientation;
a module attachment stage that installs one or more solar modules onto the one or more brackets to complete assembly for the solar table; and
a lock stage that securely locks the attached solar module to complete the assembly of the solar table; and
a table delivery zone that receives the solar table dispatched from the table assembly station for storage or delivery.

12. The system of claim 11, wherein the torque tube positioning stage comprises:
one or more proximity sensors that detect an axial position of the torque tube when the torque tube is fed from the torque tube dispenser;
a profiler that scans the torque tube, the torque tube is stopped at a first location where a first bracket hole among the plurality of bracket holes is longitudinally within a scanning range of the profiler;
a rotator that rotates the torque tube while the profiler performs a scan to locate the first bracket such that the torque tube is oriented to an angular orientation.

13. The system of claim 12, wherein the torque tube positioning stage further comprises:
a tube clamp that locks the torque tube after the torque tube is oriented to the angular orientation; and
a tube advance rail, the tube clamp slides along the tube advance rail to move the torque tube toward the bracket installation stage for attaching one or more brackets.

14. The system of claim 12 wherein the rotator comprises:
a clamp arm that is configured to be in an open position to let the torque tube pass through or in a closed position;
a clamp roller placed at a distal end of the clamp arm; and
a rotation wheel for tube rotation, when the clamp arm is in the closed position, the clamp roller firmly pushes the torque tube against the rotation wheel to enable tube rotation.

15. The system of claim 11, wherein at least part of attaching one or more brackets and part of installing one or more solar modules are implemented in parallel.

16. The system of claim 1, wherein the table assembly station further comprises:
a robot that fetches solar modules from one or more module pallets;
a module conveyor where the fetched solar modules are aligned and advanced; and
a scan station that scans the fetched solar modules and rotates one or more fetched solar modules if indicated by scan results.

17. The system of claim 16, wherein one or more module pallets are placed on a static pallet station, a rotary table, or a pallet conveyor that comprises a first section to convey loaded slippers for table assembly and a second section to dispatch empty slippers.

18. The system of claim 11, wherein the table delivery zone comprises:
a solar table rack that stacks the assembled solar table, the solar table rack is capable of holding multiple assembled solar tables.

19. The system of claim 18, wherein the table delivery zone further comprises:
a solar table rack on which the solar table rack is slidable, the solar table rack comprises a first unloading area;
wherein once the solar table rack is fully stacked, the solar table rack slides along the rack rail to the unloading area for rack picking up by a motorized vehicle for on-site installation.

20. The system of claim 19, wherein the solar table rack further comprises a second unloading area to receive an empty solar table for solar table re-loading, the first and second unloading area allow parallel solar table rack dropping and unloading operations.
